(19) United States
(12) Patent Application Publication
(10) Pub. No.: US 2024/0338533 A1
(43) Pub. Date: Oct. 10, 2024

(54) METHOD, APPARATUS AND ELECTRONIC DEVICE FOR INFORMATION PROCESSING

(71) Applicant: Beijing Youzhuju Network Technology Co., Ltd., Beijing (CN)

(72) Inventors: Jun Cao, Beijing (CN); Qingnan Jiang, Beijing (CN); Chengqi Zhao, Beijing (CN); Mingxuan Wang, Beijing (CN); Lei Li, Beijing (CN); Xiaohui Wang, Beijing (CN)

(21) Appl. No.: 18/565,685

(22) PCT Filed: Jul. 20, 2022
(86) PCT No.: PCT/CN2022/106803

§ 371 Date: Nov. 30, 2023

(30) Foreign Application Priority Data
Jul. 29, 2021 (CN) 202110866775.7

(51) Int. Cl. G06F 40/44; G06F 40/58

(52) U.S. Cl. CPC G06F 40/44; G06F 40/58

(57) ABSTRACT

A method, apparatus and electronic device for information processing. The method includes: obtaining a first hidden state vector obtained by inputting information to be translated that is expressed in a source language into a pre-trained first translation model, and a first probability distribution that the first hidden state vector is predicted as respective words in a predetermined vocabulary; obtaining, from a vector index library of a target language, at least one of target index term that satisfies a predetermined condition with the first hidden state vector; determining a second probability distribution that the second hidden state vector is predicted as the respective words in the predetermined vocabulary; determining a second probability distribution of the second hidden state vector; fusing the first and second probability distribution to obtain a fusion probability distribution; and determining a translation result with the fusion probability distribution.

### CROSS-REFERENCE TO RELATED APPLICATIONS

The present application claims priority to the Chinese Patent Application No. 202110866775.7, filed on Jul. 29, 2021, and entitled “Method, Apparatus and Electronic Device for Information Processing”, the entirety of which is incorporated herein by reference.

### FIELD

The present disclosure relates to the field of artificial intelligence technology, specifically to a method, apparatus and electronic device for information processing.

### BACKGROUND

Neural Machine Translation (NMT) has risen rapidly in recent years. Compared with statistical Machine Translation, neural networks translation is relatively simple in terms of its models, which mainly includes two parts, an encoder and a decoder. The encoder transforms the source language into a high-dimensional vector through a series of neural network transformations. The decoder is responsible for re-decoding (translating) this high-dimensional vector into the target language.

With the development of deep learning technology and the help of massive parallel corpus, the NMT model has surpassed a statistical-based methods in most languages.

### SUMMARY

The present disclosure content section is provided to briefly introduce concepts, which will be described in detail in the following detailed description sections. The present disclosure content section is not intended to identify key features or necessary features of the claimed technical solution, nor is it intended to be used to limit the scope of the claimed technical solutions.

Embodiments of the present disclosure provide a method, apparatus, and electronic device for information processing.

In the first aspect, embodiments of the present disclosure provide a method of information processing, comprising: a first hidden state vector obtained by inputting information to be translated that is expressed in a source language into a pre-trained first translation model, and a first probability distribution that the first hidden state vector is predicted as respective words in a predetermined vocabulary; obtaining, from a vector index library of a target language, at least one of target index term that satisfies a predetermined condition with the first hidden state vector, the target index term comprising a second hidden state vector; determining a second probability distribution that the second hidden state vector is predicted as the respective words in the predetermined vocabulary; fusing the first and second probability distributions to obtain a fused probability distribution; returning the fused probability distribution to the first translation model to enable the first translation model to determine a translation result according to the fusion probability distribution.

In the second aspect, embodiments of the present disclosure provide a model for information processing, comprising: a first translation model, a second translation model, an index establishing model and a fusion proportion determination model, wherein, the first translation model is configured to convert inputted information to be translated that is expressed in a source language into a first hidden state vector and predict a first probability distribution that the first hidden state vector is respective morphemes in a predetermined vocabulary of a target language; and output the first hidden state vector and the first probability distribution to a receiving fusion proportion determination model through a first predetermined remote call interface; receive a fused probability distribution output by the fusion proportion determination model, and determine a translation result corresponding to the information to be translated according to the fusion probability distribution; the second translation model is configured to decode an inputted predetermined corpus to obtain a reference hidden state vector corresponding to a plurality of predetermined morphemes of the predetermined corpus, and send the reference hidden state vector to the index establishing model; the index establishing model is configured to establish a vector index library based on the reference hidden state vector; the fusion proportion determination model is configured to fuse the first and second probability distributions to obtain a fused probability distribution.

On the third aspect, embodiments of the present disclosure provide an apparatus for information processing, comprising: a first obtaining unit is configured to obtain a first hidden state vector obtained by inputting information to be translated that is expressed in a source language into a pre-trained first translation model, and a first probability distribution that the first hidden state vector is predicted as respective words in a predetermined vocabulary; a second obtaining unit is configured to obtain, from a vector index library of a target language, at least one of target index term that satisfies a predetermined condition with the first hidden state vector, the target index term comprising a second hidden state vector; determining a second probability distribution that the second hidden state vector is predicted as the respective words in the predetermined vocabulary; a fusion unit is configured to fuse the first and second probability distributions to obtain a fused probability distribution; a translation unit is configured to return the fused probability distribution to the first translation model to enable the first translation model to determine a translation result according to the fusion probability distribution.

On the Fourth aspect, embodiments of the present disclosure provide an electronic device, comprising: one or more processors; a storage apparatus is configured to store one or more programs, when the one or more programs are performed by the one or more processors, causing the one or more processors to implement the method of information processing as described in the first aspect.

On the Fifth aspect, embodiments of the present disclosure provide a computer-readable medium, having a computer program stored thereon, the method of information processing as described in the first aspect is implemented when the program is performed by a processor.

### BRIEF DESCRIPTION OF THE DRAWINGS

The above and other features, advantages and aspects of the various embodiments of the present disclosure will become more apparent in conjunction with the accompanying drawings and with reference to the following detailed description. Throughout the drawings, the same or similar reference numerals refer to the same or similar elements. It should be understood that the drawings are schematic and that the originals and elements are not necessarily drawn to scale.

FIG. 1 is a flowchart of an embodiment of the method of information processing according to the present disclosure.

FIG. 2 is a flowchart of another embodiment of the method of information processing according to the present disclosure.

FIG. 3 is a schematic diagram of the structure of an embodiment of the model for information processing according to the present disclosure.

FIG. 4 is a comparative diagram of the use of the model for information processing shown in FIG. 3.

FIG. 5 is a flowchart of an embodiment of the apparatus for information processing according to the present disclosure.

FIG. 6 is an exemplary system architecture in which the method and apparatus for information processing of an embodiment of the present disclosure can be applied.

FIG. 7 is a schematic diagram of the basic structure of the electronic device provided according to an embodiment of the present disclosure.

### DETAILED DESCRIPTION

The following will describe the embodiments of the present disclosure in more detail with reference to the accompanying drawings. Although certain embodiments of the present disclosure are shown in the drawings, it should be understood that the present disclosure can be implemented in various forms and should not be construed as limited to the embodiments set forth herein, but rather these embodiments are provided for a more thorough and complete understanding of the present disclosure. It should be understood that the drawings and embodiments of the present disclosure are for illustrative purposes only and are not intended to limit the scope of protection of the present disclosure.

It should be understood that the various steps described in the method embodiments of the present disclosure can be performed in different orders, and/or performed in parallel. In addition, the method embodiments can include additional steps and/or omit the steps shown. The scope of the present disclosure is not limited in this regard.

The term “include” and variations thereof as used herein are open ended, i.e. “including but not limited to”. The term “based on” is “based at least in part on”. The term “one embodiment” means “at least one of embodiment”; the term “another embodiment” means “at least one of additional embodiment”; the term “some embodiments” means “at least some embodiments”. The relevant definitions of other terms will be given in the following description.

It should be noted that the concepts such as “first” and “second” mentioned in the present disclosure are only used for distinguishing different apparatuses, modules, or units, and are not used to limit the order or interdependency relationship of the functions performed by these apparatuses, modules, or units.

It should be noted that the modifications of “a/an” and “a plurality of” mentioned in the present disclosure is schematic and non-limiting, and it should be understood by those skilled in the art that unless the context clearly indicates, it should be understood that “one or more”.

The names of the messages or information exchanged among a plurality of apparatuses in the embodiments of the present disclosure are only used for illustrative purposes, and are not intended to limit the scope of these messages or information.

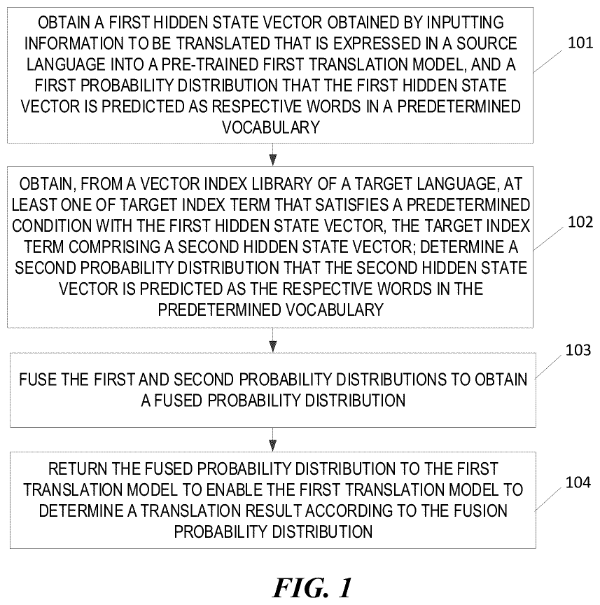

Referring to FIG. 1, the flow of an embodiment of the method of information processing according to the present disclosure is shown. As shown in FIG. 1, the method of information processing comprises the following steps:

Step 101, obtaining a first hidden state vector obtained by inputting information to be translated that is expressed in a source language into a pre-trained first translation model, and a first probability distribution that the first hidden state vector is predicted as respective words in a predetermined vocabulary.

The first translation model herein can be any Machine Learning model. For example, a Neural Machine Translation Model, etc.

The first translation model can be a pre-trained model. Training for the first translation model can be supervised training, which is not described here.

The source language herein can be any language, such as English, Chinese, French, etc. The target language can be any language other than the source language.

The above-mentioned information to be translated may include a word, phrase, sentence, sentence group, etc.

After inputting the above-mentioned information to be translated into the first translation model, the first translation model can encode the information to be translated in the source language to obtain an encoding vector. Then, the encoding vector is transformed to obtain the first hidden state vector corresponding to the target language. After the above-mentioned first hidden state vector is obtained, the first hidden state vector can be mapped to respective word in the predetermined vocabulary. For each word, the first translation model can calculate and map the first hidden state vector into the probability of the word, thereby obtaining the first probability distribution.

The predetermined vocabulary of the target language herein can be a general vocabulary or a field-specific vocabulary. The predetermined vocabulary can be selected according to a specific application scenario.

If the inputted information to be translated comprises a plurality of words, a code can be numbered corresponding to each word. For example, the codes corresponding to the three words “I”, “love”, and “hometown” in “I love hometown” can be numbered. hj can be used to represent the codes of the above three words respectively, j=1, 2, 3.

In an implementation, the above-mentioned first hidden state vector and the above-mentioned first probability distribution can be obtained from the first translation model using a pre-established a first predetermined remote procedure call (RPC) interface.

The above-mentioned remote call interface is pre-established in advance based on a predetermined call protocol. Through the RPC interface, the first hidden state vector and the first probability distribution of the current information to be translated that is generated by the first translation model can be obtained at any time.

Step 102, obtaining, from a vector index library of a target language, at least one of target index term that satisfies a predetermined condition with the first hidden state vector, the target index term comprising a second hidden state vector; determining a second probability distribution that the second hidden state vector is predicted as the respective words in the predetermined vocabulary.

The above-mentioned vector index library of the target language can be pre-established. The target index library can include a plurality of reference hidden state vectors. Each reference hidden state vector can correspond to a target language morpheme in the predetermined vocabulary. The predetermined vocabulary herein can be a vocabulary corresponding to the target language. The vocabulary can include a plurality of morphemes of the target language. The target language morpheme herein can be a word, phrase, or sentence, etc. Each morpheme in the predetermined vocabulary can correspond to a tag. The tags of different morphemes can be different.

The above-mentioned vector index library can store the reference hidden state vector and the tag corresponding to the reference hidden state vector in association. The tag corresponding to the reference hidden state vector herein can be the same as the tag of the morpheme of the target language corresponding to the reference hidden state vector in the predetermined vocabulary.

The above-mentioned vector index library can be established by:

First, inputting a predetermined parallel corpus into a pre-trained second translation model for decoding by the second translation model, to obtain a reference hidden state vector corresponding to a plurality of morphemes of the target language in the predetermined corpus, the predetermined parallel corpus comprising predetermined corpus in the source language and predetermined corpus in the target language of synonyms.

The second translation model herein can be a model of the same structure as the first translation model. In addition, the above-mentioned second translation model can also be obtained using the same training data and the same training method as the first translation model.

The above-mentioned predetermined parallel corpus may comprise a first predetermined corpus of the above-mentioned source language and a second corpus of the target language, the above-mentioned second corpus is the same as the synonyms of the above-mentioned first predetermined corpus.

In addition, the above-mentioned predetermined parallel corpus may also be a user-customized parallel corpus.

The first predetermined corpus and the second predetermined corpus in the predetermined parallel corpus can respectively includes a plurality of morphemes, the morphemes herein can be words, words, sentences, etc. The reference hidden state vector corresponding to the above-mentioned respective morpheme can be obtained through the above-mentioned forced decoding.

By inputting the above-mentioned predetermined parallel corpus into the second translation model, the second translation model can determine the correspondence between morphemes in the source language and morphemes in the target language. Morphemes in the target language can correspond to the reference hidden state vectors. In addition, the tag of a morpheme in the target language can be the same as the tag of the same morpheme in the predetermined vocabulary of the target language.

Secondly, based on the reference hidden state vector establishing the vector index library.

The first hidden state vector may be matched with a plurality of reference hidden state vector, determining at least one of second hidden state vector according to the matching result.

Specifically, the distance between the first hidden state vector and a plurality of the reference hidden state vectors can be calculated, and at least one of reference hidden state vector satisfying the predetermined condition based on the distance size is determined as the second hidden state vector. In some application scenarios, the predetermined condition can be that the distance is less than the predetermined distance threshold. In other application scenarios, the predetermined condition can be the top k of the smallest distance between the first hidden state vector and the plurality of reference hidden state vectors. Wherein k is an integer greater than or equal to 1 and less than the number of reference hidden state vectors.

After determining at least one of second hidden state vector, at least one of target index term can be further determined. The target index term can include the second hidden state vector, the tag corresponding to the second hidden state vector, and the distance between the second hidden state vector and the first hidden state vector.

Furthermore, it can be determined that the second hidden state vector is mapped to the second probability distribution of respective morpheme in the predetermined vocabulary.

When determining the above-mentioned second probability distribution, a respective normalized weights of a plurality of target index terms can be calculated based on the similarity between the first hidden state vector and the second hidden state vector in the plurality of target index terms. The normalized weight distribution can be understood as the probability distribution of the target index term. By merging the probabilities of a plurality of target index terms with the same morpheme, the probability distribution of the morphemes contained in the target index term in the predetermined vocabulary is obtained. The probability of words not appearing in the target index term in the predetermined vocabulary is set to 0. The probability distribution on the predetermined vocabulary obtained in this way is the second probability distribution.

Specifically, the above-mentioned second probability distribution can be determined according to the following formula:

$${p}_{2} ( {y}_{t} ) = \frac{{\sum }_{m = 1}^{u} K ( {q}_{t} , {k}_{i} ; σ \vert ( {y}_{t} = {v}_{i} ) )}{{\sum }_{i = 1}^{r} K ( {q}_{t} , {k}_{i} ; σ )} ; \qquad ( 1 )$$

wherein
qₜ is the first hidden state vector corresponding to the t-th morpheme to be translated in the source language; r is the number of second hidden state vectors determined from the vector index library that satisfies the predetermined condition with the first hidden state vector; ki is the tag corresponding to the i-th second hidden state vector in the above-mentioned r second hidden state vectors. K(qₜ,kᵢ;σ) is the kernel function that takes qᵢ,kᵢ;σ as a parameter. u is the number of at least one of hidden state corresponding to the same tag vᵢ.

$${\sum }_{m = 1}^{u} K ( {q}_{t} , {k}_{i} ; σ \vert ( {y}_{t} = {v}_{i} ) )$$

is a sum of u kernel function values corresponding to the second hidden states of the same tag vi.
p₂(yₜ) is the probability that the second hidden state vector corresponding to the t-th morpheme in the language to be translated is in the predetermined vocabulary.

The above-mentioned kernel function K(q,k;σ) adopts a Gaussian kernel,

$$K ( {q}_{t} , {k}_{i} ; σ ) = exp ( \frac{{‖ {q}_{t} - {k}_{i} ‖}^{2}}{σ} ) ; \qquad ( 2 )$$

wherein, |qₜ−kᵢ∥² is the square Euclidean distance between qt and ki.

A bandwidth parameter σ can be represented by the exponential activation function:

$$σ = exp ( {W}_{1} \times [ {q}_{t} ; {\tilde{k}}_{t} ] + {b}_{1} ) ; wherein \qquad ( 3 )$$

$${\tilde{k}}_{t} = {\sum }_{i = 1}^{r} {k}_{i} ; \qquad ( 4 )$$

\tilde{k}ₜ is the mean of r second hidden state vector that satisfies a predetermined condition with the first hidden state vector qt, the above-mentioned W1 and b1 are trainable parameters.

In this way, obtaining the second hidden state vector is mapped to the second probability distribution of predetermined vocabulary. It should be noted herein that for morphemes (corresponding to predetermined tags) in the vocabulary that are not involved in the Attribute-Value Pairs determined from the index library, the probability distribution corresponding to the second hidden state vector is 0.

In some optional implementations, the above-mentioned from the vector index library of the target language, obtaining at least one of target index term that satisfies a predetermined condition with the first hidden state vector, the first hidden state vector may be sent to the above-mentioned vector index library with the second predetermined remote call interface, the vector index library may determine at least one of target index term in its own plurality of reference hidden state vector.

After determining at least one of target index term, the above-mentioned vector index library can be used to return the target index term through the above-mentioned second predetermined remote call interface.

The second predetermined remote call interface can index in the vector index library at any time and obtaining the index results in real time.

Step 103, the fusing the first and second probability distribution to obtain a fused probability distribution.

The fusion proportion corresponding to the first and second probability distribution, respectively, can be determined according to the predetermined method, and the first and second probability distribution can be fused in accordance with the respective proportions to obtain the fusion probability distribution. Specifically, determining a sum of a product of the first probability distribution and the first fusion proportion and a product of the second probability and the second fusion proportion as the fused probability distribution.

The fusion probability distribution can for example be represented by the following formula:

$$p ( {y}_{t} ) = λ \times {p}_{2} ( {y}_{t} ) + ( 1 - λ ) \times {p}_{1} ( {y}_{t} ) ; \qquad ( 5 )$$

wherein, p₁(yₜ) is the first probability distribution, p₂(yₜ) is the second probability distribution.

It can be understood that the fusion probability distribution can include the probability corresponding to each morpheme in the predetermined vocabulary. That is, the fusion probability distribution includes the probability that the current morpheme to be translated is mapped to respective morpheme in the predetermined vocabulary under the influence of the index item given by the above-mentioned index library.

Step 104, returning the fused probability distribution to the first translation model to enable the first translation model to determine a translation result according to the fusion probability distribution.

The morpheme of the template language corresponding to the tag with the highest probability value in the fusion probability distribution as the translation result.

The embodiments of the present disclosure provide a method of information processing by obtaining the first hidden state vector obtained by inputting the information to be translated that is expressed in the source language into the pre-trained first translation model, and a first probability distribution that the first hidden state vector is predicted as respective words in a predetermined vocabulary; obtaining, from a vector index library of a target language, at least one of target index term that satisfies a predetermined condition with the first hidden state vector, the target index term comprising a second hidden state vector; determining a second probability distribution that the second hidden state vector is predicted as the respective words in the predetermined vocabulary; fusing the first and second probability distributions to obtain a fused probability distribution; returning the fused probability distribution to the first translation model to enable the first translation model to determine a translation result according to the fusion probability distribution. It is realized to intervene in the decoding process of the neural machine translation model based on nearest-neighbor retrieval with the constructed data index of the to-be-applied fields, so that when the trained machine translation model is applied to specific fields, there is no need to re-train and adjust the parameters of model, that is, can be applied to the to-be-applied fields to obtain a more accurate translation results.

In related technologies, when the trained translation model is usually applied to the to-be-applied fields, the parallel expectation of the to-be-applied fields to be applied needs to be used to retrain and adjust the translation model parameters, so that the translation model trained with the general corpus cannot be directly applied to specific fields for translation, so that the field expression of the translation model is poor. The solution provided in the embodiment, however, by constructing a data index in the to-be-applied and based on nearest-neighbor retrieval, the decoding process of the neural machine translation model is intervened, so that when the trained machine translation model is applied specific fields, there is no need to re-train and adjust the parameters of model, that is, more accurate translation results can be obtained. This can improve the field performance of the translation model.

In addition, in related fields, the parallel corpus in the to-be-applied fields can be stored in advance in the form of Attribute-Value Pairs of whole sentence. When the translation model is applied to the to-be-applied fields, the translation model queries based on the above-mentioned stored attribute-value Pairs during translation, which has high precision. However, the solution can only return the corresponding translation unless the user input completely hits the original text. When the information to be translated does not appear in the above-mentioned pre-stored attribute-value Pairs, accurate translation cannot be achieved, so such a solution lacks generalization. In this solution, the fusion result of different probability distributions of the same information to be translated are used to determine the translation result, which improves the generalization of the translation model compared to using the method of translation based on the stored attribute-value pairs.

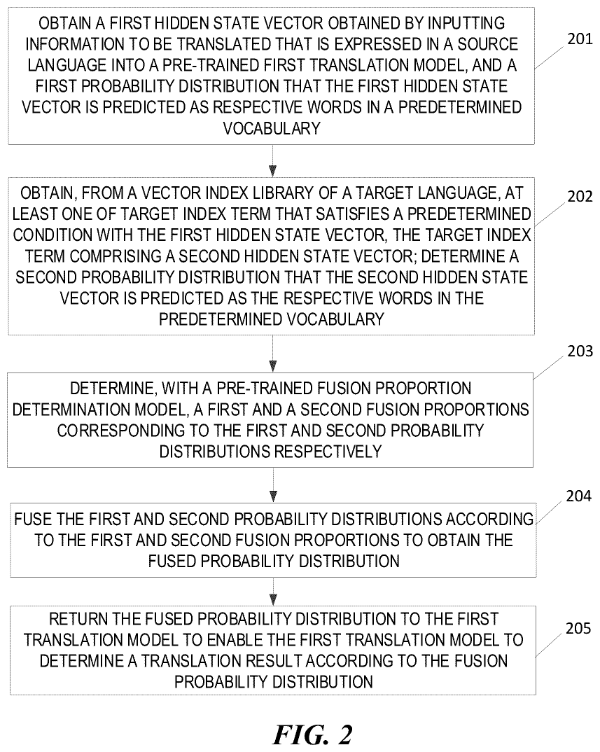

Referring to FIG. 2, which shows a flowchart of another embodiment of the method of information processing according to the present disclosure. As shown in FIG. 2, the method includes the following steps:

Step 201, obtaining a first hidden state vector obtained by inputting information to be translated that is expressed in a source language into a pre-trained first translation model, and a first probability distribution that the first hidden state vector is predicted as respective words in a predetermined vocabulary.

Step 202, obtaining, from a vector index library of a target language, at least one of target index term that satisfies a predetermined condition with the first hidden state vector, the target index term comprising a second hidden state vector; determining a second probability distribution that the second hidden state vector is predicted as the respective words in the predetermined vocabulary.

The specific implementation of steps 201 to 202 can refer to steps 101 and 102 of the embodiments shown in FIG. 1, which are not repeated herein.

Step 203, determining, with a pre-trained fusion proportion determination model, a fusion proportion corresponding to the first and second probability distributions respectively.

The above-mentioned fusion proportion determination model may include a multilayer perceptron.

The above-mentioned fusion proportion determination module can first determine the second fusion proportion corresponding to the second probability distribution. The second fusion proportion can be expressed as follows:

$$λ = sigmoid ( {W}_{3} \times Re LU ( {W}_{2} \times [ {q}_{t} ; {\tilde{k}}_{1 t} ] + {b}_{2} ) + {b}_{3} ) ; \qquad ( 6 )$$

$$wherein , {\tilde{k}}_{1 t} = {\sum }_{i = 1}^{r} {w}_{i} \times {k}_{i} ; \qquad ( 7 )$$

$${w}_{i} = \frac{K ( {q}_{t} , {k}_{i} ; σ )}{{\sum }_{i = 1}^{r} K ( {q}_{t} , {k}_{i} ; σ )} ; \qquad ( 8 )$$

qₜ is the first hidden state vector corresponding to the t-th morpheme to be translated in the source language; r is the number of second hidden state vectors that satisfies the predetermined condition with the first hidden state vector determined from the vector index library; ki is the tag corresponding to the i-th second hidden state vector in the above-mentioned r second hidden state vectors. K(qₜ,kᵢ;σ) is the kernel function that takes qₜ,kᵢ;σ as a parameter: W₂; b₂; W₃; b₃ is a trainable parameter.

The above K(qₜ,kᵢ;σ) can be a Gaussian kernel function. The expression of K(qₜ,kᵢ;σ) can refer to formula (2), which will not be repeated herein.

The two neural networks that estimate a bandwidth parameters σ and a fusion weight coefficients λ require additional training. During training, the tag yₜ of step t is first transformed into a one-hot probability distribution on the predetermined vocabulary, and the tag smoothing is performed on the one-hot probability distribution to obtain the smoothed tag distribution pₗₛ (v) represented by the following formula, where V is the predetermined vocabulary size of the target language.

$${P}_{ls} ( v \vert {y}_{t} ) \{ \begin{matrix}0 \text{.9} , & {y}_{t} \\ \frac{0.1}{V - 1} , & v \neq {y}_{t}\end{matrix} . \qquad ( 9 )$$

The loss function of a tag is the cross entropy between the fused probability distribution p(yₜ) and the smoothed tag distribution pₗₛ (v|yₜ).

The loss function of a translation sample is a sum of the loss functions of all tokens on the target side.

During training, the translation samples corresponding to a plurality of target language tags are packaged into a batch, and the loss function of each batch is a sum of loss functions of all sentence in this batch. The gradient of the loss function with respect to the parameters in the probability distribution fusion module is computed with the back propagation algorithm, and the parameters of the model are updated with an Adam optimizer. After a predetermined number of iterations, a converged model is obtained.

After obtaining the second fusion proportion, the first fusion proportion can be determined, the first fusion proportion is 1.

Step 204, fusing the first and second probability distributions according to the first and second fusion proportions to obtain the fused probability distribution.

The first and second probability distribution may be fused by referring to the method of formula (5).

Step 205, returning the fused probability distribution to the first translation model to enable the first translation model to determine a translation result according to the fusion probability distribution.

Compared with the embodiment shown in FIG. 1, the embodiment highlights the content of determining the fusion proportion corresponding to the first and second probability distribution according to the fusion proportion determination model, and realizes the self-adaptation to realize the fusion proportion, which can improve the portability of the method of information processing provided in the present disclosure.

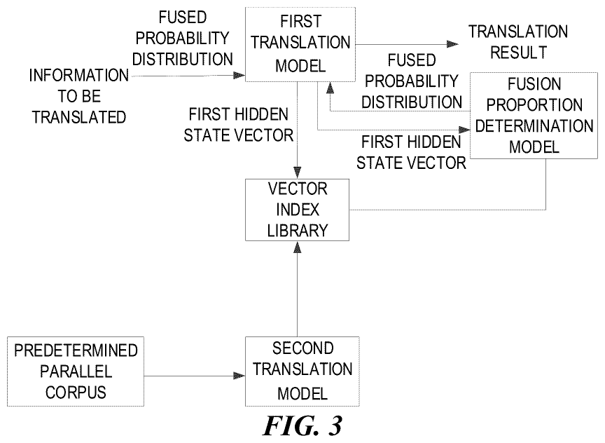

Referring to FIG. 3, which shows a schematic diagram of the structure of the model for information processing provided according to the present disclosure. As shown in FIG. 3, the model for information processing includes a first translation model, a second translation model, an index establishing model and a fusion proportion determination model.

The first translation model is configured to convert inputted information to be translated that is expressed in a source language into a first hidden state vector and predict a first probability distribution that the first hidden state vector is respective morphemes in a predetermined vocabulary of a target language; and output the first hidden state vector and the first probability distribution to a receiving fusion proportion determination model through a first predetermined remote call interface; receive a fused probability distribution output by the fusion proportion determination model, and determine a translation result corresponding to the information to be translated according to the fusion probability distribution;

The second translation model is configured to decode an inputted predetermined corpus to obtain a reference hidden state vector corresponding to a plurality of predetermined morphemes of the predetermined corpus, and send the reference hidden state vector to the index establishing model.

The index establishing model is configured to establish a vector index library based on the reference hidden state vector; obtain at least one of target index term that satisfies a predetermined condition with the first hidden state vector from a vector index library of the target language, the target index term comprising a second hidden state vector; and output the second hidden state vector to the fusion proportion determination model through a second predetermined remote call interface.

The fusion proportion determination model is configured to determine a second probability distribution that the second hidden state vector is predicted as respective words in the predetermined vocabulary; determine respective fusion proportions for the first and second probability distributions, and fuse the first and second probability distributions based on the fusion proportions to obtain a fused probability distribution.

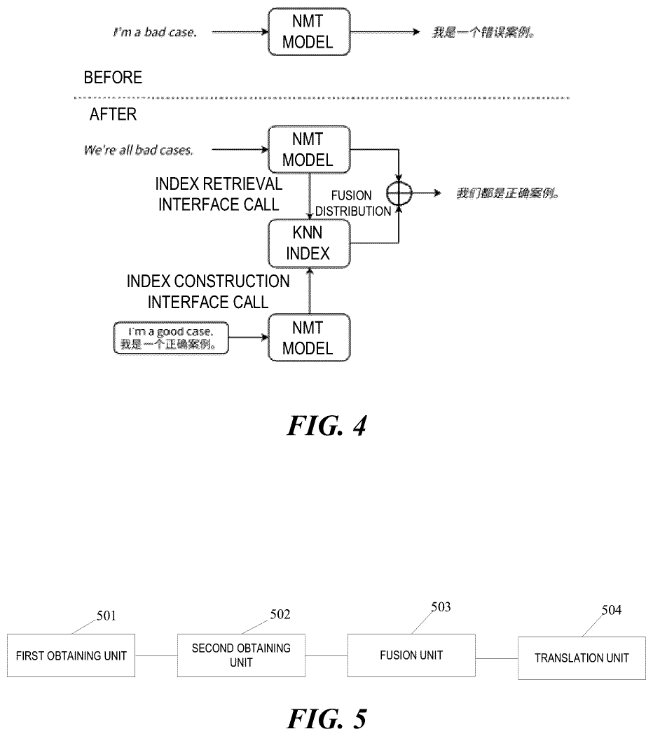

Referring to FIG. 4, which shows a comparative diagram of the use of the model for information processing shown in FIG. 3. As shown in FIG. 4, the NMT model can be used for the first and second translation model. The KNN index can be indexed in the index library of FIG. 3 using nearest neighbor search.

The first translation model can translate the English message to be translated “I'm a bad case” into Chinese “ [symbol] ”.

After using the above-mentioned model for information translation, searching, since the second hidden state vector that satisfies the predetermined condition with the first hidden state vector obtained from the first translation model in the index library, the second hidden state vector can affect the probability of respective morpheme that the currently translated morpheme is mapped to the predetermined vocabulary of Chinese, which cause the translation result to change.

In the above-mentioned index library, a plurality of reference hidden state vectors and corresponding tags of a plurality of reference hidden state vectors can be determined based on the inputting parallel corpus. The second translation model (NMT model can determine the reference hidden state vector and the tags of the words in the predetermined vocabulary corresponding to the reference hidden state vector based on the inputting parallel corpus “I'm a good case”; “ [symbol] ”) can establish an index based on the reference hidden state vector and the reference hidden state vector.

The information to be translated “We're all bad cases” is input into the first translation model (NMT model), the first translation model sends the generated first hidden state vector to the index library by the index retrieval interface. The index library can match the plurality of reference hidden state vectors therein to obtain at least one of second hidden state vector. The first hidden state vector can be predicted as the first probability distribution of respective morpheme in the predetermined vocabulary of the target language, and the second hidden state vector is predicted to be fused to the second probability distribution of respective word in the predetermined vocabulary to obtain a fusion probability distribution. The translation result determined based on the fusion probability distribution is “ [symbol] ”.

Further referring to FIG. 5, as an implementation of the methods shown in the above-mentioned respective figure, the present disclosure provides some embodiments of an apparatus for information processing, which corresponds to the embodiment of method shown in FIG. 1, and can be specifically applied to various electronic devices.

As shown in FIG. 5, the apparatus for information processing of embodiment includes: a first obtaining unit 501, a second obtaining unit 502, a fusion unit 503, and a translation unit 504, wherein the first obtaining unit 501 configured to obtain a first hidden state vector obtained by inputting information to be translated that is expressed in a source language into a pre-trained first translation model, and a first probability distribution that the first hidden state vector is predicted as respective words in a predetermined vocabulary; the second obtaining unit 502 configured to obtain, from a vector index library of a target language, at least one of target index term that satisfies a predetermined condition with the first hidden state vector, the target index term comprising a second hidden state vector; determining a second probability distribution that the second hidden state vector is predicted as the respective words in the predetermined vocabulary; the fusion unit 503 configured to fuse the first and second probability distributions to obtain a fused probability distribution; the translation unit 504 configured to return the fused probability distribution to the first translation model to enable the first translation model to determine a translation result according to the fusion probability distribution.

In some optional implementations, the fusion unit 503 is further configured to; determining, with a pre-trained fusion proportion determination model, a first and a second fusion proportions corresponding to the first and second probability distributions respectively; and fusing the first and second probability distributions according to the first and second fusion proportions to obtain the fused probability distribution.

In some optional implementations, the fusion unit 503 is further configured to: determining a sum of a product of the first probability distribution and the first fusion proportion and a product of the second probability and the second fusion proportion as the fused probability distribution.

In some optional implementations, the second fusion proportion corresponding to the second probability distribution is determined by the following formula;

$$λ = sigmoid ( {W}_{3} Re LU ( {W}_{2} [ {q}_{t} ; {\tilde{k}}_{t} ] + {b}_{2} ) + {b}_{3} ) ; wherein$$

$${\tilde{k}}_{1 t} = {\sum }_{i = 1}^{k} {w}_{i} \times {k}_{i} ;$$

$${w}_{i} = \frac{K ( {q}_{t} , {k}_{i} ; σ )}{{\sum }_{i = 1}^{k} K ( {q}_{t} , {k}_{i} ; σ )} ;$$

qₜ is the first hidden state vector; kᵢ is the i-th second hidden state vector; i is greater than or equal to 1, less than or equal to k, k is the number of target index terms that satisfies the predetermined conditions;
K(q,k;σ) is the kernel function that takes σ as a parameter.

In some optional implementations, the vector index library is established by: inputting a predetermined parallel corpus into a pre-trained second translation model for decoding by the second translation model, to obtain a reference hidden state vector corresponding to a plurality of morphemes of the target language in the predetermined corpus, the predetermined parallel corpus comprising predetermined corpus in the source language and predetermined corpus in the target language of synonyms; and establishing the vector index library based on a plurality of the reference hidden state vectors, wherein the second translation model is a same translation model as the first translation model and is obtained by trained using a same training scheme.

In some optional implementations, the first obtaining unit 501 is further configured to: obtaining the first hidden state vector and the first probability distribution with a first predetermined remote call interface.

In some optional implementations, the second obtaining unit 502 is further configured to: obtaining the at least one of target index term satisfies the predetermined condition with the first hidden state vector from the vector index library of the target language with a second predetermined remote call interface.

The embodiments of the present disclosure provide the method, apparatus, and electronic device for information processing by obtaining the first hidden state vector obtained by inputting the information to be translated that is expressed in the source language into the pre-trained first translation model, and a first probability distribution that the first hidden state vector is predicted as respective words in a predetermined vocabulary; obtaining, from a vector index library of a target language, at least one of target index term that satisfies a predetermined condition with the first hidden state vector, the target index term comprising a second hidden state vector; determining a second probability distribution that the second hidden state vector is predicted as the respective words in the predetermined vocabulary; fusing the first and second probability distributions to obtain a fused probability distribution; returning the fused probability distribution to the first translation model to enable the first translation model to determine a translation result according to the fusion probability distribution. It is realizing to intervene in the decoding process of the neural machine translation model based on nearest-neighbor retrieval with the constructed data index of the to-be-applied fields, so that when the trained machine translation model is applied specific fields, there is no need to re-train and adjust the parameters of model, that is, can be applied to the to-be-applied fields to obtain a more accurate translation results. It can improve the field performance of the machine translation model. It improves the real-time performance and generalizability of the machine translation model without adjusting the parameters of the machine translation model.

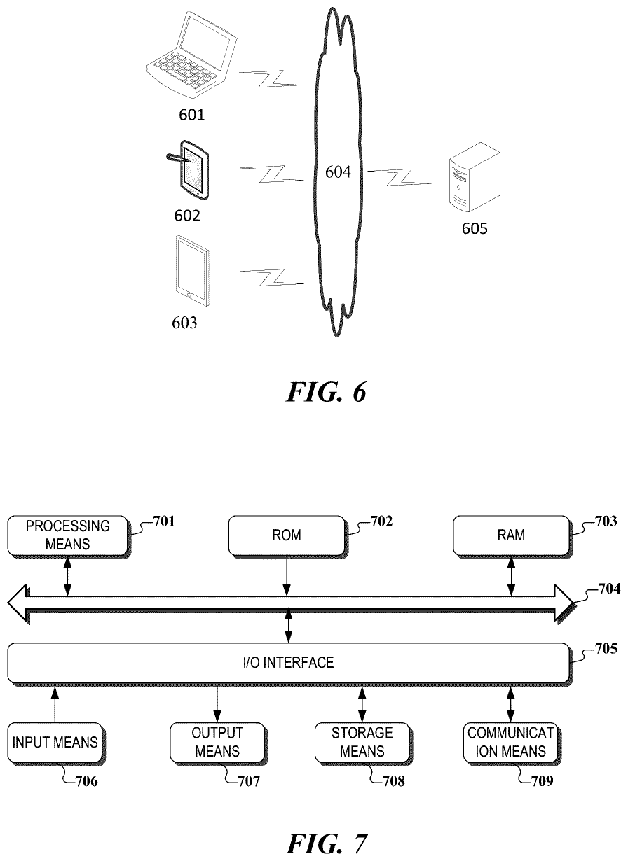

Referring to FIG. 6, which shows an exemplary system architecture to which an information display method of an embodiment of the present disclosure may be applied.

As shown in FIG. 6, the system architecture may include terminal devices 601, 602, 603, a network 604, and a server 605. The network 604 is used to provide media of communication links between the terminal devices 601, 602, 603 and the server 605. The network 604 may include various connection types, such as wired, wireless communication links, or fiber optic cables.

The terminal devices 601, 602, and 603 may interact with the server 605 through the network 604 to receive or send messages, etc. On the terminal devices 601, 602, 603 may be installed a variety of client applications, such as web browser applications, search applications, news and information applications. The client application in the terminal devices 601, 602, and 603 may receive user instructions and perform corresponding functions according to the user instructions, such as the information to be translated is sent to the server 605 according to the user instructions.

The terminal devices 601, 602, 603 may be hardware or software. When the terminal devices 601, 602, 603 are hardware, they may be various electronic devices with a display screen and supporting web browsing, including but not limited to, smart phones, tablet computers, e-book readers, MP3 (Moving Picture Experts Group Audio Layer III) players, MP4 (Moving Picture Experts Group Audio Layer IV) players, laptop computers and desktop computers, etc. When the terminal devices 601, 602, 603 are software, they may be installed in the above listed electronic devices, and may be implemented as multiple software or software modules (such as software or software modules for providing distributed services) or as a single software or software module. It is not intended to limit in this regard.

The server 605 may be a server that provides various services, for example, analyze and process the information to be translated sent by the terminal devices 601, 602, 603 to obtain a translation result, and send the translation result to the terminal devices 601, 602, 603.

It should be noted that the method of information processing provided in the embodiments of the present disclosure may be performed by the server 604, and correspondingly, the apparatus for information processing may be disposed in the server 604. In addition, the method of information processing may also be performed by the terminal devices 601, 602, 603, and correspondingly, the apparatus for information processing may be disposed in the terminal devices 601, 602, 603.

It should be understood that the number of terminal devices, networks, and servers shown in FIG. 6 is only schematic. Depending on practical needs, any number of terminal devices, networks, and servers may be provided.

Reference is made to FIG. 7 below, which shows a structural schematic diagram of an electronic device (e.g., the terminal device or server in FIG. 6) suitable for implementing the embodiments of the present disclosure. The terminal device in the embodiments of the present disclosure may include, without limitation to, a mobile terminal such as a mobile phone, a laptop computer, a digital broadcast receiver, a PDA (personal digital assistant), a PAD (tablet computer), a PMP (portable multimedia player), an on-board terminal (e.g., on-board navigation terminal) and the like, as well as a fixed terminal such as a digital TV, a desktop computer and the like. The electronic device shown in FIG. 7 is merely an example and should not be construed to impose any limitations on the functionality and use scope of the embodiments of the present disclosure.

As shown in FIG. 7, the electronic device may comprises processing means (e.g., a central processor, a graphics processor) 701 which is capable of performing various appropriate actions and processes in accordance with programs stored in a read only memory (ROM) 702 or programs loaded from storage means 708 to a random access memory (RAM) 703. In the RAM 703, there are also stored various programs and data required by the electronic device 700 when operating. The processing means 701, the ROM 702 and the RAM 703 are connected to one another via a bus 704. An input/output (I/O) interface 705 is also connected to the bus 704.

Usually, the following means may be connected to the I/O interface 705: input means 706 including a touch screen, a touch pad, a keyboard, a mouse, a camera, a microphone, an accelerometers, a gyroscope, or the like; output means 707, such as a liquid-crystal display (LCD), a loudspeaker, a vibrator, or the like; storage means 708, such as a magnetic tape, a hard disk or the like; and communication means 709. The communication means 709 allows the electronic device 700 to perform wireless or wired communication with other device so as to exchange data with other device. While FIG. 7 shows the electronic device 700 with various means, it should be understood that it is not required to implement or have all of the illustrated means. Alternatively, more or less means may be implemented or exist.

Specifically, according to the embodiments of the present disclosure, the procedures described with reference to the flowchart may be implemented as computer software programs. For example, the embodiments of the present disclosure comprise a computer program product that comprises a computer program embodied on a non-transitory computer-readable medium, the computer program including program codes for executing the method shown in the flowchart. In such an embodiment, the computer program may be loaded and installed from a network via the communication means 709, or installed from the storage means 708, or installed from the ROM 702. The computer program, when performed by the processing means 701, perform the above functions defined in the method of the embodiments of the present disclosure.

It is noteworthy that the computer readable medium of the present disclosure can be a computer readable signal medium, a computer readable storage medium or any combination thereof. The computer readable storage medium may be, for example, but is not limited to, an electronic, magnetic, optical, electromagnetic, infrared or semiconductor system, apparatus or device, or any combination of the foregoing. More specific examples of the computer readable storage medium may include, without limitation to, the following: an electrical connection with one or more conductors, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer readable storage medium may be any tangible medium including or storing a program that may be used by or in conjunction with an instruction executing system, apparatus or device. In the present disclosure, the computer readable signal medium may include data signals propagated in the baseband or as part of the carrier waveform, in which computer readable program code is carried. Such propagated data signals may take a variety of forms, including without limitation to electromagnetic signals, optical signals, or any suitable combination of the foregoing. The computer readable signal medium may also be any computer readable medium other than a computer readable storage medium that may send, propagate, or transmit a program for use by, or in conjunction with, an instruction executing system, apparatus, or device. The program code contained on the computer readable medium may be transmitted by any suitable medium, including, but not limited to, a wire, a fiber optic cable, RF (radio frequency), etc., or any suitable combination thereof.

In some implementations, the client and server may communicate utilizing any currently known or future developed network protocol such as HTTP (HyperText Transfer Protocol) and may be interconnected with digital data communications (e.g., communication networks) of any form or medium. Examples of communication networks include local area networks (“LANs”), wide area networks (“WANs”), inter-networks (e.g., the Internet), and end-to-end networks (e.g., ad hoc end-to-end networks), as well as any currently known or future developed networks.

The above computer readable medium may be contained in the above electronic device; or it may exist separately and not be assembled into the electronic device.

The above computer readable medium carries one or more programs which, when performed by the electronic device, cause the electronic device to: obtaining a first hidden state vector obtained by inputting information to be translated that is expressed in a source language into a pre-trained first translation model, and a first probability distribution that the first hidden state vector is predicted as respective words in a predetermined vocabulary; obtaining, from a vector index library of a target language, at least one of target index term that satisfies a predetermined condition with the first hidden state vector, the target index term comprising a second hidden state vector; determining a second probability distribution that the second hidden state vector is predicted as the respective words in the predetermined vocabulary; fusing the first and second probability distributions to obtain a fused probability distribution; returning the fused probability distribution to the first translation model to enable the first translation model to determine a translation result according to the fusion probability distribution.

Computer program code for carrying out operations of the present disclosure may be written in one or more program designing languages or a combination thereof, which include without limitation to an object oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Units involved in the embodiments of the present disclosure as described may be implemented in software or hardware. The name of a unit does not form any limitation on the module itself.

The functionality described above may at least partly be performed, at least in part, by one or more hardware logic components. For example and in a non-limiting sense, exemplary types of hardware logic components that can be used include: field-programmable gate arrays (FPGA), application specific integrated circuits (ASICs), application specific standard products (ASSPs), systems on chips (SOCs), complex programmable logic devices (CPLDs), etc.

In the context of the present disclosure, the machine readable medium may be a tangible medium that can retain and store programs for use by or in conjunction with an instruction execution system, apparatus or device. The machine readable medium of the present disclosure can be a machine readable signal medium or a machine readable storage medium. The machine readable medium may include, but is not limited to, an electronic, magnetic, optical, electromagnetic, infrared or semiconductor system, apparatus or device, or any combination of the foregoing. More specific examples of the machine readable storage medium may include, without limitation to, the following: an electrical connection based on one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

The foregoing description is merely illustration of the preferred embodiments of the present disclosure and the technical principles used herein. Those skilled in the art should understand that the disclosure scope involved therein is not limited to the technical solutions formed from a particular combination of the above technical features, but should also cover other technical solutions formed by any combination of the above technical features or their equivalent features without departing from the above disclosure concepts, e.g., technical solutions formed by replacing the above features with technical features having similar functions disclosed (without limitation) in the present disclosure.

In addition, although various operations have been depicted in a particular order, it should not be construed as requiring that the operations be performed in the particular order shown or in sequential order of execution. Multitasking and parallel processing may be advantageous in certain environments. Likewise, although the foregoing discussion includes several specific implementation details, they should not be construed as limiting the scope of the present disclosure. Some features described in the context of separate embodiments may also be realized in combination in a single embodiment. On the contrary, various features described in the context of a single embodiment may also be realized in multiple embodiments, either individually or in any suitable sub-combinations.

While the present subject matter has been described using language specific to structural features and/or method logic actions, it should be understood that the subject matter defined in the appended claims is not necessarily limited to the particular features or actions described above. On the contrary, the particular features and actions described above are merely exemplary forms of realizing the claims. With respect to the apparatus in the above embodiment, the specific manner in which each module performs an operation has been described in detail in the embodiments relating to the method, and will not be detailed herein.

1. A method of information processing, comprising:
obtaining a first hidden state vector obtained by inputting information to be translated that is expressed in a source language into a pre-trained first translation model, and a first probability distribution that the first hidden state vector is predicted as respective words in a predetermined vocabulary;
obtaining, from a vector index library of a target language, at least one of target index term that satisfies a predetermined condition with the first hidden state vector, the target index term comprising a second hidden state vector; determining a second probability distribution that the second hidden state vector is predicted as the respective words in the predetermined vocabulary;
fusing the first and second probability distributions to obtain a fused probability distribution;
returning the fused probability distribution to the first translation model to enable the first translation model to determine a translation result according to the fusion probability distribution.

2. The method of claim 1, wherein the fusing the first and second probability distributions to obtain a fused probability distribution comprises:
determining, with a pre-trained fusion proportion determination model, a first and a second fusion proportions corresponding to the first and second probability distributions respectively; and
fusing the first and second probability distributions according to the first and second fusion proportions to obtain the fused probability distribution.

3. The method of claim 1, wherein the fusing the first and second probability distributions to obtain a fusion probability distribution comprises:
determining a sum of a product of the first probability distribution and the first fusion proportion and a product of the second probability and the second fusion proportion as the fused probability distribution.

4. The method of claim 2, wherein the second fusion proportion corresponding to the second probability distribution is determined as:
$$λ = sigmoid ( {W}_{3} Re LU ( {W}_{2} [ {q}_{t} ; {\tilde{k}}_{t} ] + {b}_{2} ) + {b}_{3} ) ; wherein$$
$${\tilde{k}}_{t} = {\sum }_{i = 1}^{k} {w}_{i} \times {k}_{i} ;$$
$${w}_{i} = \frac{K ( {q}_{t} , {k}_{i} ; σ )}{{\sum }_{i = 1}^{k} K ( {q}_{t} , {k}_{i} ; σ )} ;$$
qₜ is the first hidden state vector; kᵢ is the i-th second hidden state vector; i is greater than or equal to 1 and less than or equal to k, and k is the number of target index terms that satisfies the predetermined condition;
K(q,k;σ) is a kernel function with σ as a parameter.

5. The method of claim 1, wherein the vector index library is established by:
inputting a predetermined parallel corpus into a pre-trained second translation model for decoding by the second translation model, to obtain a reference hidden state vector corresponding to a plurality of morphemes of the target language in the predetermined corpus, the predetermined parallel corpus comprising predetermined corpus in the source language and predetermined corpus in the target language of synonyms; and
establishing the vector index library based on a plurality of the reference hidden state vectors, wherein
the second translation model is a same translation model as the first translation model and is obtained by trained using a same training scheme.

6. The method of claim 1, wherein the obtaining a first hidden state vector obtained by inputting information to be translated that is expressed in a source language into a pre-trained first translation model, and the first hidden state vector being predicted as a first probability distribution of respective words in a predetermined vocabulary comprises:
obtaining the first hidden state vector and the first probability distribution with a first predetermined remote call interface.

7. The method of claim 1, wherein the obtaining, from a vector index library of a target language, at least one of target index term that satisfies a predetermined condition with the first hidden state vector comprises:
obtaining the at least one of target index term satisfies the predetermined condition with the first hidden state vector from the vector index library of the target language with a second predetermined remote call interface.

8-11. (canceled)

12. An electronic device comprising:
one or more processors;
a storage apparatus is configured to store one or more programs, when the one or more programs are performed by the one or more processors, causing the one or more processors to implement acts comprising:
obtaining a first hidden state vector obtained by inputting information to be translated that is expressed in a source language into a pre-trained first translation model, and a first probability distribution that the first hidden state vector is predicted as respective words in a predetermined vocabulary;
obtaining, from a vector index library of a target language, at least one of target index term that satisfies a predetermined condition with the first hidden state vector, the target index term comprising a second hidden state vector; determining a second probability distribution that the second hidden state vector is predicted as the respective words in the predetermined vocabulary;
fusing the first and second probability distributions to obtain a fused probability distribution;
returning the fused probability distribution to the first translation model to enable the first translation model to determine a translation result according to the fusion probability distribution.

13. The electronic device of claim 12, wherein the fusing the first and second probability distributions to obtain a fused probability distribution comprises:
determining, with a pre-trained fusion proportion determination model, a first and a second fusion proportions corresponding to the first and second probability distributions respectively; and
fusing the first and second probability distributions according to the first and second fusion proportions to obtain the fused probability distribution.

14. The electronic device of claim 12, wherein the fusing the first and second probability distributions to obtain a fusion probability distribution comprises:
determining a sum of a product of the first probability distribution and the first fusion proportion and a product of the second probability and the second fusion proportion as the fused probability distribution.

15. The electronic device of claim 13, wherein the second fusion proportion corresponding to the second probability distribution is determined as:
$$λ = sigmoid ( {W}_{3} Re LU ( {W}_{2} [ {q}_{t} ; {\tilde{k}}_{t} ] + {b}_{2} ) + {b}_{3} ) ; wherein$$
$${\tilde{k}}_{t} = {\sum }_{i = 1}^{k} {w}_{i} \times {k}_{i} ;$$
$${w}_{i} = \frac{K ( {q}_{t} , {k}_{i} ; σ )}{{\sum }_{i = 1}^{k} K ( {q}_{t} , {k}_{i} ; σ )} ;$$
qₜ is the first hidden state vector; kᵢ is the i-th second hidden state vector; i is greater than or equal to 1 and less than or equal to k, and k is the number of target index terms that satisfies the predetermined condition;
K(q,k;σ) is a kernel function with σ as a parameter.

16. The electronic device of claim 12, wherein the vector index library is established by:
inputting a predetermined parallel corpus into a pre-trained second translation model for decoding by the second translation model, to obtain a reference hidden state vector corresponding to a plurality of morphemes of the target language in the predetermined corpus, the predetermined parallel corpus comprising predetermined corpus in the source language and predetermined corpus in the target language of synonyms; and
establishing the vector index library based on a plurality of the reference hidden state vectors, wherein
the second translation model is a same translation model as the first translation model and is obtained by trained using a same training scheme.

17. The electronic device of claim 12, wherein the obtaining a first hidden state vector obtained by inputting information to be translated that is expressed in a source language into a pre-trained first translation model, and the first hidden state vector being predicted as a first probability distribution of respective words in a predetermined vocabulary comprises:
obtaining the first hidden state vector and the first probability distribution with a first predetermined remote call interface.

18. The electronic device of claim 12, wherein the obtaining, from a vector index library of a target language, at least one of target index term that satisfies a predetermined condition with the first hidden state vector comprises:
obtaining the at least one of target index term satisfies the predetermined condition with the first hidden state vector from the vector index library of the target language with a second predetermined remote call interface.

19. A non-transitory computer-readable storage medium having a computer program stored thereon, wherein the computer program, when performed by a processor, implementing acts comprising:
obtaining a first hidden state vector obtained by inputting information to be translated that is expressed in a source language into a pre-trained first translation model, and a first probability distribution that the first hidden state vector is predicted as respective words in a predetermined vocabulary;
obtaining, from a vector index library of a target language, at least one of target index term that satisfies a predetermined condition with the first hidden state vector, the target index term comprising a second hidden state vector; determining a second probability distribution that the second hidden state vector is predicted as the respective words in the predetermined vocabulary;
fusing the first and second probability distributions to obtain a fused probability distribution;
returning the fused probability distribution to the first translation model to enable the first translation model to determine a translation result according to the fusion probability distribution.

20. The non-transitory computer-readable storage medium of claim 19, wherein the fusing the first and second probability distributions to obtain a fused probability distribution comprises:
determining, with a pre-trained fusion proportion determination model, a first and a second fusion proportions corresponding to the first and second probability distributions respectively; and
fusing the first and second probability distributions according to the first and second fusion proportions to obtain the fused probability distribution.

21. The non-transitory computer-readable storage medium of claim 19, wherein the fusing the first and second probability distributions to obtain a fusion probability distribution comprises:
determining a sum of a product of the first probability distribution and the first fusion proportion and a product of the second probability and the second fusion proportion as the fused probability distribution.

22. The non-transitory computer-readable storage medium of claim 20, wherein the second fusion proportion corresponding to the second probability distribution is determined as:
$$λ = sigmoid ( {W}_{3} Re LU ( {W}_{2} [ {q}_{t} ; {\tilde{k}}_{t} ] + {b}_{2} ) + {b}_{3} ) ; wherein$$
$${\tilde{k}}_{t} = {\sum }_{i = 1}^{k} {w}_{i} \times {k}_{i} ;$$
$${w}_{i} = \frac{K ( {q}_{t} , {k}_{i} ; σ )}{{\sum }_{i = 1}^{k} K ( {q}_{t} , {k}_{i} ; σ )} ;$$
qₜ is the first hidden state vector; kᵢ is the i-th second hidden state vector; i is greater than or equal to 1 and less than or equal to k, and k is the number of target index terms that satisfies the predetermined condition;
K(q,k;σ) is a kernel function with σ as a parameter.

23. The non-transitory computer-readable storage medium of claim 19, wherein the vector index library is established by:
inputting a predetermined parallel corpus into a pre-trained second translation model for decoding by the second translation model, to obtain a reference hidden state vector corresponding to a plurality of morphemes of the target language in the predetermined corpus, the predetermined parallel corpus comprising predetermined corpus in the source language and predetermined corpus in the target language of synonyms; and
establishing the vector index library based on a plurality of the reference hidden state vectors, wherein
the second translation model is a same translation model as the first translation model and is obtained by trained using a same training scheme.

24. The non-transitory computer-readable storage medium of claim 19, wherein the obtaining a first hidden state vector obtained by inputting information to be translated that is expressed in a source language into a pre-trained first translation model, and the first hidden state vector being predicted as a first probability distribution of respective words in a predetermined vocabulary comprises:
obtaining the first hidden state vector and the first probability distribution with a first predetermined remote call interface.
